(19) United States
(12) Patent Application Publication
(10) Pub. No.: US 2003/0046310 A1
(43) Pub. Date: Mar. 6, 2003

(54) Tracking files of storage media and enabling users to quickly associate such files with the storage media on which they are stored

(75) Inventors: David Goodman, New York, NY (US); Jason Chang, Brooklyn, NY (US); Pratik Mehta, New York, NY (US)

Correspondence Address: STRAUB & POKOTYLO, 1 BETHANY ROAD, SUITE 83, BUILDING 6, HAZLET, NJ, 07730, US

(73) Assignee: Polytechnic University

(21) Appl. No.: 09/941,072

(22) Filed: Aug. 28, 2001

(51) Int. Cl. G06F 12/00

(52) U.S. Cl. 707/200

(57) ABSTRACT

Helping users to track the contents (e.g., files) stored on various types of storage media without requiring the user to insert the storage media into a read device of a machine, such as a floppy drive of a personal computer, and/or helping users to locate desired content (e.g., a file) without having to insert numerous storage media into a read device of a machine. The contents of a given storage medium may be determined by associating a machine-readable label with each machine-readable medium, and the contents thereof. When a user wants to know the contents of the machine-readable medium, they merely need to have another device (e.g., a Palm Pilot provided with a bar code scanner) read the label. The device may include a database synchronized with a database managed by the machine which is used to write content to, and/or read content from, the machine-readable medium. A file may be found by (i) allowing a user to enter one or more search parameters into the device, such as a handheld, untethered device, (ii) generating a search query from the entered parameter(s), (iii) getting a search result(s) indicating the storage medium that includes the desired content, and (iv) helping the user to associate the indicated storage medium with the physical storage medium actually storing the desired content.

### 1. BACKGROUND OF THE INVENTION

1.1 Field of the Invention

The present invention concerns tracking the contents, such as files, stored on storage media, such as diskettes, compact disks, DVDs, Zip Disks, etc. More specifically, the present invention concerns permitting users to determine quickly the contents of a storage media, without the need to read the actual storage media itself. The present invention also concerns helping users to determine the particular storage medium on which a desired file is stored.

1.2 Related Art

The present invention relates generally to helping users track the contents of various types of storage media. For example, people use floppy diskettes, ZIP disks, and writeable compact disks to store text files (formatted, e.g., in Microsoft Word, Adobe Acrobat, etc.), files associated with computer applications (e.g., database backups, spreadsheets, MIDI sequences, etc.), images (formatted as, e.g., gifs, JPEGs, etc.), computer programs and applications, sound files (e.g., MPEG 3 encoded songs), video files, etc. Many individuals will have on the order of tens, or even hundreds, of such disks. Some individuals will have even more.

Besides memorization, people typically determine the contents of a storage medium in one of two ways—through a machine actually reading the storage medium, or through a human-readable label associated with (e.g., affixed to) the storage medium. Sadly, each of these methods has serious drawbacks.

Having a machine (e.g., a disk drive of a personal computer) actually read the storage media (e.g., a diskette) is often an arduous task, particularly if the file one is looking for can be on any one of tens, if not hundreds, of disks. This task becomes all the more frustrating if the machine is turned off and needs to be initialized (e.g., if a personal computer needs to be started).

Although having a human-readable label associated with (e.g., affixed to) each of the storage mediums (e.g., diskettes) avoids the need to use a machine (e.g., a disk drive of a personal computer) to read the storage medium in order to determine the contents of that storage medium, this method also has serious drawbacks. First, labels are typically printed or written with a “snapshot” of the contents of the storage medium at a given time. However, most users delete files and add files to such storage media, and often do so frequently. Changing the labels to keep up with such changes to the contents is often not practical. Further, as the density (storage amount-to-physical size) of storage media increases, the number of files stored may become too large to easily write on and read from a human-readable label.

In view of foregoing, there is a need for improved methods and/or apparatus to help users track the contents of various types of storage media. Such methods and/or apparatus should not require the storage media to be actually read by a machine (e.g., inserted into the appropriate drive of a personal computer). Further, such methods and/or apparatus should be able to accommodate a large number of files, and should be flexible so that the addition or deletion of files can be easily tracked.

### 2. SUMMARY OF THE INVENTION

The present invention meets the aforementioned needs by helping users track the contents of various types of storage media, without requiring the storage media to be actually read by a machine (e.g., inserted into the appropriate drive of a personal computer). The present invention may do so by associating a machine-readable label with each machine-readable medium, and the contents thereof. In this way, when a user wants to know the contents of the diskette, they merely need to have a machine (e.g., a Palm Pilot provided with a bar code scanner) read the label. The machine may include a database synchronized with a database which was maintained by a machine used to write files to, and/or read files from, the machine-readable medium.

The present invention may also help users locate desired content (e.g., a file) without having to insert numerous storage media into a machine (e.g., a personal computer) for reading that media. The present invention may do so by (i) allowing a user to enter one or more search parameters into a device (e.g., a handheld, untethered device) other than the read/write machine (or alternatively, into the read/write machine itself), (ii) generating a search query from the entered parameter(s), (iii) getting a search result(s) indicating the storage medium that includes the desired content (file(s)), and (iv) helping the user to associate the indicated storage medium with the physical storage medium actually storing the desired content (file(s)).

### 3. BRIEF DESCRIPTION OF THE DRAWINGS

FIG. 1 illustrates an exemplary environment in which the present invention may operate.

FIG. 2 is a bubble-chart that illustrates operations that may be performed in the context of the invention.

FIG. 3 is a flow diagram of an exemplary method(s) that may be used to effect content (file) tracking operations at a machine for reading from, and writing to, storage media.

FIG. 4 is a flow diagram of an exemplary method(s) that may be used to effect content (file) tracking operations at a device other than the read/write machine, such as a handheld, untethered device.

FIG. 5 is a block diagram an exemplary apparatus that may be used to effect various operations in accordance with the present invention.

FIG. 6 is a messaging diagram that illustrates communications that may occur when a new file is written to a new disk, in accordance with one exemplary embodiment of the present invention.

FIG. 7 is a messaging diagram that illustrates communications that may occur pursuant to a synchronization request, in accordance with one exemplary embodiment of the present invention.

FIG. 8 is a messaging diagram that illustrates communications that may occur pursuant to a request to list contents, in accordance with one exemplary embodiment of the present invention.

FIG. 9 is a messaging diagram that illustrates communications that may occur pursuant to a request to find a file(s), in accordance with one exemplary embodiment of the present invention.

### 4. DETAILED DESCRIPTION

The present invention involves novel methods, apparatus and data structures for helping users track the contents of various types of storage media. The following description is presented to enable one skilled in the art to make and use the invention, and is provided in the context of particular embodiments and methods. Various modifications to the disclosed embodiments and methods will be apparent to those skilled in the art, and the general principles set forth below may be applied to other embodiments, methods and applications. Thus, the present invention is not intended to be limited to the embodiments and methods shown, and the inventors regard their invention as the following disclosed methods, apparatus, data structures and materials and any other patentable subject matter to the extent that they are patentable.

In the following, an exemplary environment, in which various aspects of the invention may operate, is introduced in 4.1. Then, functions that may be performed by the present invention are introduced in 4.2. Thereafter, exemplary operations, methods, data structures and apparatus are described in 4.3. Then, examples illustrating operations of an exemplary embodiment of the present invention are provided in 4.4. Finally, some conclusions about the present invention are set forth in 4.5. First, however, some terms used in the specification are defined.

A “machine-readable medium” is a medium that can store data or information (referred to generally as “content”) that can be read by a machine. Such content is typically of use or interest to people. An example of a machine-readable medium is a magnetic diskette that can store information which is readable by a disk drive.

A “machine-readable label” is a label that carries data or information that can be read by a machine. An example of such a “machine-readable label” is a bar code label. As can be appreciated from this example, a machine-readable label can often be perceived by humans, but is generally not readily distinguishable by humans. For example, people can see bar codes, but they typically have no meaning to people. Indeed, people are often unable to distinguish one bar code from another. As should be appreciated, some machine-readable labels cannot be perceived, or at least easily perceived, by humans.

A “human-readable label” is a label that can be perceived by humans. Further, such labels may have meaning to people and, in any event, people will often be able to distinguish one human-readable label from another. An example of a human-readable label is a sticker with typewritten file names.

A “hybrid label” is one with a machine-readable part and a human-readable part.

A “file” is a complete, named collection of information, such as a program, a set of data used by a program, or a user-created document for example. A file is the basic unit of storage that enables a computer to distinguish one set of information from another, and binds a conglomeration of instructions, numbers, words, images, audio information, etc., into a coherent unit that a user can retrieve, change, delete, save or send to an output device.

A “volume label” is a name associated with a storage medium, such as a diskette for example.

### 4.1 EXEMPLARY ENVIRONMENT

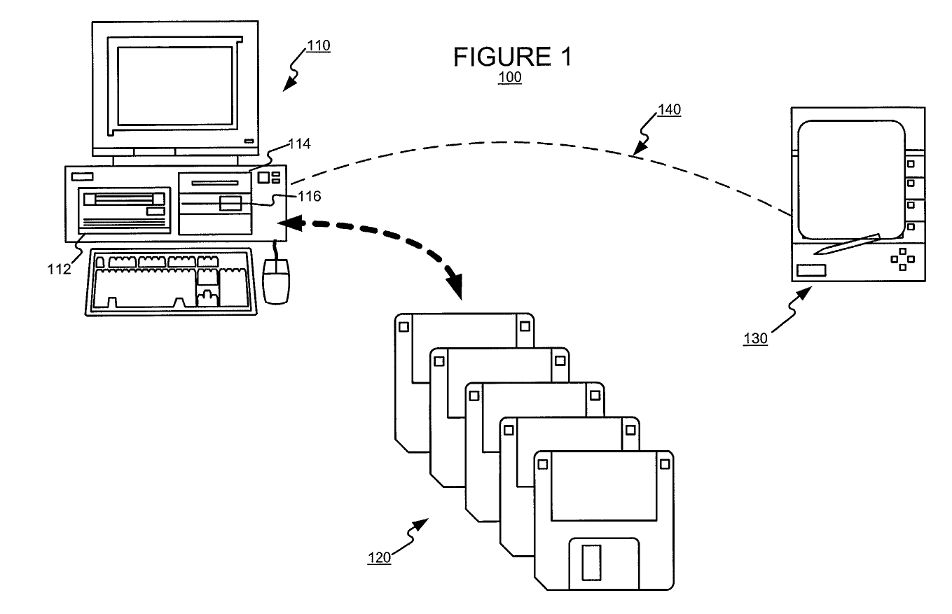

FIG. 1 is a high-level diagram of an exemplary environment 100 in which the present invention may be used. As shown, a personal computer 110 may have a number of drives for writing information on and/or reading information from, disks. Such drives may include, for example, an optical read/write drive 112 for use with writeable compact disks, a Zip drive 114 for use with high-capacity Zip disks, and a floppy drive 116 for use with floppy diskettes. As indicated by the heavy dashed line, a number of diskettes 120 may be used with the floppy drive 116.

Also shown is a separate (handheld, untethered) device 130, such as a so-called Palm-Pilot from Palm of Santa Clara, Calif. for example. As is well-understood by those skilled in the art, information on such a (handheld, untethered) device 130 can be synchronized (i.e., made coherent) with information on a personal computer 110, and vice versa. Information exchanged during such synchronization may be communicated over a cable 140, though other types of physical communications (e.g., wireless) may be used.

### 4.2 FUNCTIONS THAT MAY BE PERFORMED

A first aspect of the present invention may function to help users track the contents of various types of storage media, without requiring the storage media to be actually read by a machine (e.g., inserted into the appropriate drive of a personal computer). This first aspect of the invention may be accomplished by associating a machine-readable label with each machine-readable medium, and the contents thereof. In this way, when a user wants to know the contents of the diskette, they merely need to have a machine (e.g., a Palm Pilot provided with a bar code scanner) read the label. The machine may include a database synchronized with a database which was maintained by a machine used to write files to, and/or read files from, the machine-readable medium.

A second aspect of the present invention may function to help users locate desired content (e.g., a file) without having to insert numerous storage media into a machine (e.g., a personal computer) for reading that media. The present invention may do so by (i) allowing a user to enter one or more search parameters into a device (e.g., a handheld, untethered device) other than the read/write machine (or alternatively, into the read/write machine itself), (ii) generating a search query from the entered parameter(s), (iii) getting a search result(s) indicating the storage medium that includes the desired content (file(s)), and (iv) helping the user to associate the indicated storage medium with the physical storage medium actually storing the desired content (file(s)).

### 4.3 EXEMPLARY OPERATIONS, METHODS, DATA STRUCTURES, AND APPARATUS

Exemplary operations that may be performed by the present invention are described in 4.3.1. Then, exemplary methods and data structures for implementing such operations of the present invention are described in 4.3.2. Exemplary apparatus for implementing various operations of the present invention are described in 4.3.3. Finally, some alternative or optional features are descried in 4.3.4.

### 4.3.1 EXEMPLARY OPERATIONS

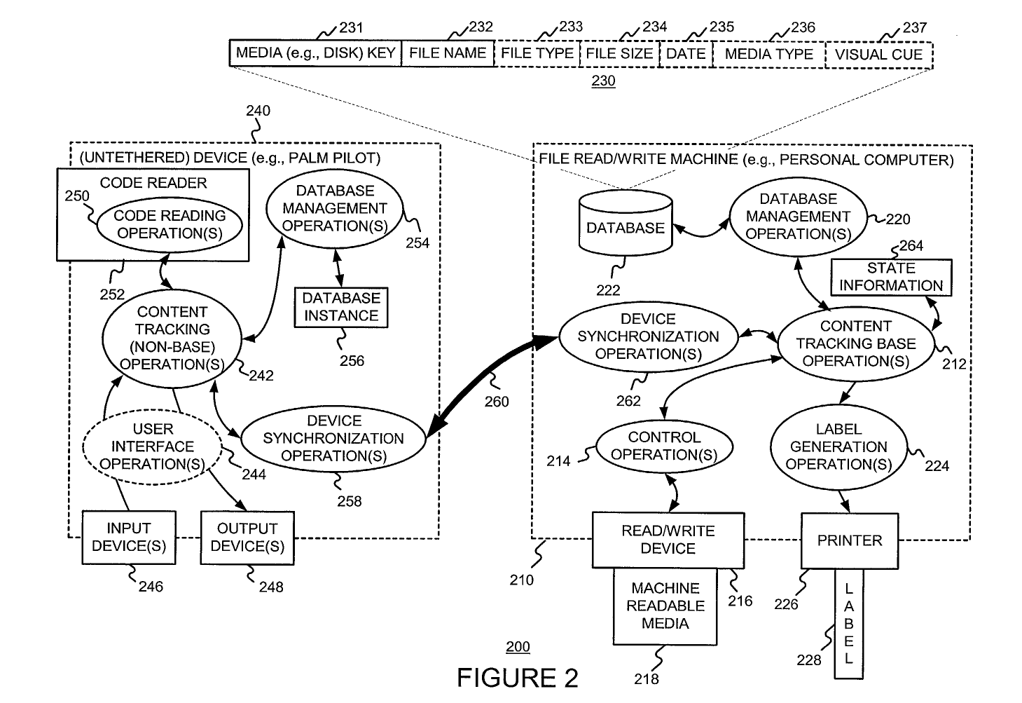

FIG. 2 is a bubble-chart illustrating operations that may be performed in accordance with the present invention. In the following, operations that may be performed by a machine (e.g., a personal computer) 210 for reading from and/or writing to a machine-readable medium 218 are introduced first. Then, operations that may be performed by another device (e.g., a handheld, untethered device, such as a Palm Pilot) 240 are introduced.

Content tracking base operations 212 may be performed in a machine (e.g., a personal computer) 210 that may also include a database 222 controlled by database management operation(s) (e.g., Access from Microsoft Corporation of Bellevue, Wash.) 220, control operations 214 for controlling a device (e.g., a disk drive(s)) 216 used to read from and/or write to a machine-readable medium (e.g., a diskette) 218, and a label generation operation (e.g., Codabar from Azalia of Seattle, Wash.) 224 for controlling a printer (or some other means of writing machine-readable information) 226 to generate a label 228. The machine 210 may also include device synchronization operation(s) 262 to permit information stored on the machine 210 and information stored on a (handheld, untethered) device 240 to be synchronized. Finally, the machine 210 may store state information 264 used by the content tracking base operation(s) 212.

Basically, when files are first written to a machine-readable medium 218, the content tracking base operation(s) 212 will, based on state information 264, associate a unique identifier (and a unique volume label) with the machine-readable medium 218. Further, when files are first written to the machine-readable medium 218, the content tracking base operation(s) 212 will also provide unique information to the label generation operation(s) 224 for having the printer 226 generate a label (such as a bar code label for example) 228. In alternative embodiments, other types of machine-readable labels can be generated instead.

Associated with this first write operation, as well as with other writes or deletions, the content tracking base operation(s) 212 may update the contents of a database 222 (e.g., insert records or items, delete records or items, change records or items, etc.) via a database management operation(s) 220.

As shown, the database 222 may include a number of records or items 230. Each record or item 230 will typically include a field 231 for storing a key for uniquely identifying the storage medium and a field 232 for storing the name of a file stored on that identified storage medium. Thus, a single storage medium (e.g., identified via the media key value) 218 can have more than one associated record or item 230. Each of the records or items 230 may include further information such as, for example, a field 233 for storing the type of file (e.g., text, Word, Acrobat, executable, gif, jpeg, mp3, PowerPoint, etc.), a field 234 for storing the size of the file, a field 235 for storing the date (e.g., creation and/or last modified) of the file, a field for storing the media type 236 (e.g., floppy disk, Zip disk, compact disk, DVD, etc.), and a field 237 for encoding a human-readable visual cue that may be included on the label 228. Naturally, the media type 236 may be encoded within the media key 231.

Content tracking (non-base) operations 242 may be performed in a device (e.g., a handheld, untethered device such as a Palm Pilot) 240 that may also include a database 256 controlled by database management operation(s) 254 (e.g., Satellite Forms from Pumatech of San Jose, Calif.), a code reader (e.g., a bar code scanner) 252 operating under the control of code reading (e.g., scanning) operation(s) 250, input device(s) (e.g., a stylus pen) 246 and output device(s) (e.g., a display and a audio output means) 248. The content tracking (non-base) operation(s) 242 may include user interface operation(s) 244 for permitting interaction with a user of the (handheld, untethered) device 240.

The (handheld, untethered) device 240 may also include device synchronization operation(s) 258 to permit information stored on the machine 210 and information stored on the (handheld, untethered) device 240 to be synchronized (e.g., via link 260). After synchronization, the database instance 256 should reflect the information stored in the database 222 of the read/write machine 210.

The content tracking (non-base) operation(s) 242 may function to accept information from a machine-read (e.g., scanned) label (Recall 228) associated with (e.g., affixed to) a storage medium, and use such information, as a key, to find matching items or records in the database instance 256. The file names (and perhaps other information) associated with the matching items or records may then be displayed (or otherwise rendered) to a user via output device(s) 248. In this way, a user can determine the contents of a storage medium without placing it in the read/write device 216 of the machine 210.

The content tracking (non-base) operation(s) 242 may also function to accept search parameters from a user. More specifically, the user interface operation(s) 244 may prompt the user to input information via the input device(s) 246. The accepted parameters may then be used to generate a search query used by the database management operation(s) 254 to find matching records or items in the database instance 256. The results will indicate which storage medium or storage media store the file(s) with parameter(s) matching the search query. Such results can be used to help the user locate the storage medium with the desired content (files) in a number of ways. Alternatively, such operations, or a separate instance of such operations, may be performed on the read/write machine 210.

For example, if the label (Recall 228) includes a human-readable visual cue (Recall 237), that visual cue may be displayed to the user via output device 248. The user may then use this information to quickly locate the desired storage medium based on the human-readable visual cue included on the label associated with (e.g., affixed to) the storage medium. One exemplary visual cue could include a sequence of n shapes of m possible colors. Therefore, if m=8 (e.g., white, black, purple, blue, green, yellow, orange, red) and n=2 or 3, 64 or 512 (mⁿ) labels, respectively, could be provided with unique visual cues. These numbers could be increased by varying the type of shape. For example, if there are four possible shapes (e.g., circle, square, triangle, star), (8=4)ⁿ labels could be provided with unique visual cues.

Alternatively, or in addition, the media type can be rendered to the user via the output device 248.

Alternatively, or in addition, the user may quickly scan successive candidate storage media until a match with the search result(s) is indicated. For example, a non-match may be audibly indicated by a lower frequency buzz, while a match may be audibly indicated by a higher frequency beep.

Having introduced exemplary operations that may be performed in accordance with the invention, exemplary methods that may be used to effect such operations, and exemplary data structures that may be created and/or used by such operations are described in 4.3.2 below. Then, exemplary apparatus for effecting such operations and storing such information are described in 4.3.3 below.

### 4.3.2 EXEMPLARY METHODS AND DATA STRUCTURES

Many of the operations illustrated in FIG. 2 can be effected with known methods and available products—the content tracking base and non-base operations, as well as their interaction with such known operations, are new. For example, the database management operations 220 and database 222 in the machine 210 may be effected using Access from Microsoft Corporation of Bellevue, Wash. The control operations 214 for controlling the read/write device 216 may be effected using available device drivers, often included in the Windows family of operating systems from Microsoft. The label generation operation(s) 224 may be effected using Codabar or other bar-coding software from Azalia of Seattle, Wash. The printer 226 may be the Label Writer EL60 from Dymo Corporation of Stamford, Conn. The device synchronization operations 262 and 258 residing on both the read/write machine 210 and the (handheld, untethered) device 240, respectively, may be effected using the Palm operating system from Palm of Santa Clara, Calif. The reading (e.g., scanning) operations 250 may be performed by the SPT 1700 from Symbol Technologies of Holtsville, N.Y. As is known, in a typical scanning operation, a user points the scanner at a label (or brings the label to the scanner) and initiates a scan (e.g., by pressing a button). In response, the scanner generates a light beam and detects light reflected back from the label in order to determine the encoded information. The database management operation(s) 254 may be effected using Satellite Forms from Pumatech of San Jose, Calif. Naturally, may of these operations may be effected using other products, or by other means.

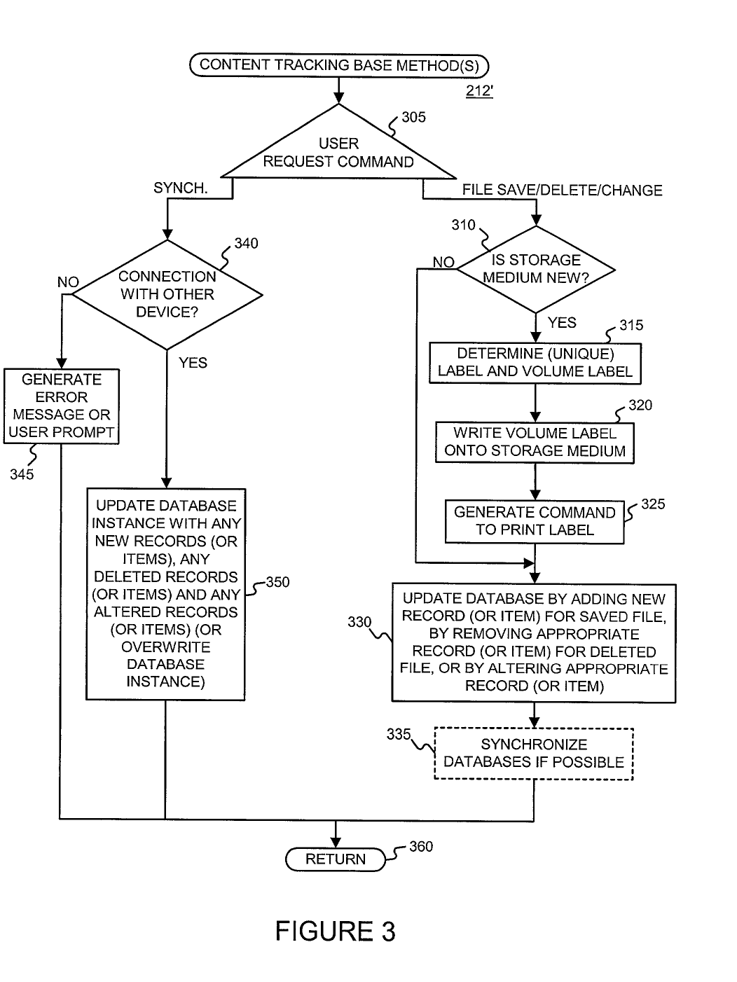

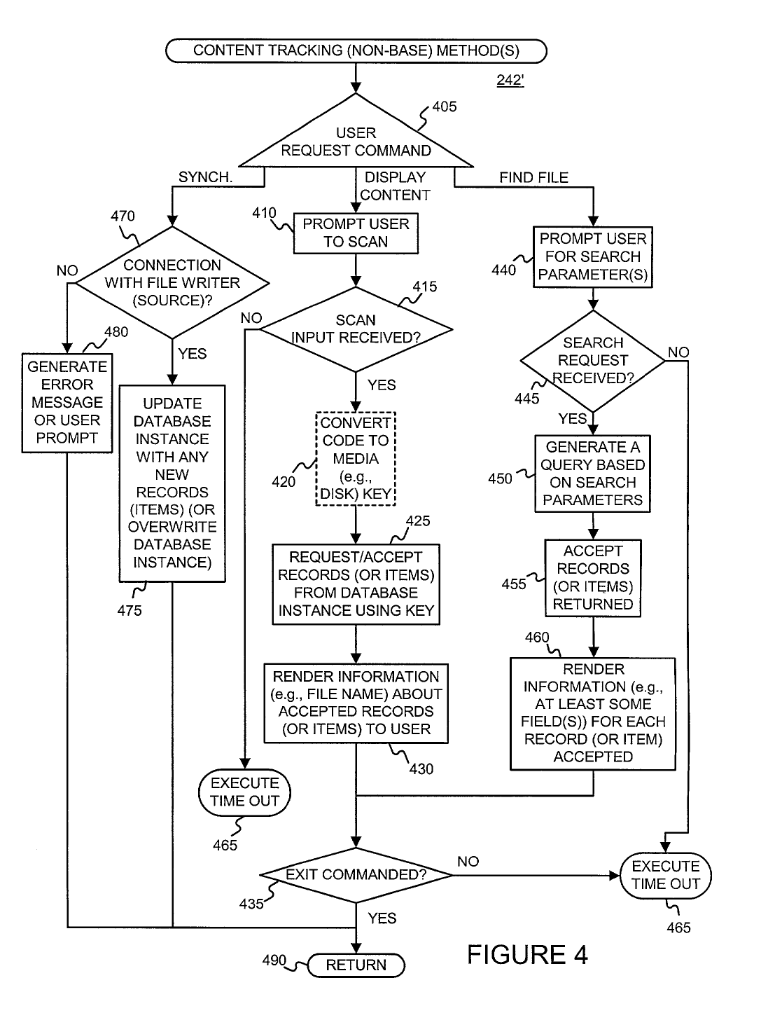

Exemplary methods that may be used to effect the content tracking base operation 212 and the content tracking (non-base) operation 242 are now described below with reference to FIGS. 3 and 4, respectively.

FIG. 3 is a flow diagram of an exemplary method 212′ that may be used to effect content tracking base operations 212. At conditional branch point 305, it is determined what type, if any, of user command has been entered.

If the user has requested a synchronization operation, the method 212′ flows to conditional branch point 340 which determines whether or not a (handheld, untethered) device “is connected with” (i.e., can communicate with) the base read/write machine. If not, an error message may be generated, as indicated by block 345. Alternatively, or in addition, a prompt to connect the (handheld, untethered) device may be provided to the user. Referring back to conditional branch point 340, if a (handheld, untethered) device is connected with the base read/write machine, the database instance on the (handheld, untethered) device (Recall e.g., 256 of FIG. 2.) may be updated to reflect any new records (or items), any deleted records (or items), and/or any altered records (or items). Alternatively, the database instance may simply be overwritten with data from the database of the file read/write base machine (Recall, e.g., 222 of FIG. 2.). The method 212′ may then be left via RETURN node 360.

Referring back to conditional branch point 305, if the user requests a file to be saved, or deleted, or changed, the method 212′ branches to conditional branch point 310 which determines whether the storage medium, associated with the file, is new. Alternatively, if the method 212′ is run in the background, it 212′ may be invoked upon the insertion of a storage medium (e.g., when a user inserts a diskette into a floppy drive), and may start at conditional branch point 310.

In the following, the term “unique volume label” uniquely identifies a storage medium, and may be written onto the storage medium. Therefore, if the storage medium is a diskette, the unique volume label may be a unique label written onto the diskette by a floppy disk drive, and that may be subsequently read by a floppy drive. The term “label” also uniquely identifies a storage medium, but is associated with (e.g., affixed to) the storage medium. Therefore, if the storage medium is a diskette, the label may be a bar code label affixed to the case of the diskette, and that may be subsequently read by a bar code reader. Although the unique volume label, and the label of a given storage medium may be the same, or encode the same information, this is not necessarily the case.

Referring back to conditional branch point 310, recall that it is determined whether or not a storage medium is new. This may be done, for example, by comparing the unique volume label, if any, of the storage medium, with stored state information (Recall, e.g., 264 of FIG. 2.). If the storage medium is determined to be new, the method 212′ continues to block 315 where a unique label and a unique volume label are determined. For example, these labels may be determined from state information 264, such as a counter that is incremented for each new storage medium for example. Then, as indicated by blocks 320 and 325, the unique volume label is written onto the storage medium, and a command to print (or otherwise generate) a unique label associated with the storage medium is generated. Referring back to FIG. 2, this command may be passed to the label generation operation 224. The user may then associate the printed unique label with the storage medium (e.g., by affixing it to a so-called “jewel-box” case or cartridge used to hold the storage medium). Alternatively, the unique label may be automatically associated with the storage medium (i.e., without (further) user intervention) in another way. As indicated by block 330, the database may be updated to reflect saved or deleted files. For example, this may be done by adding a new record (or item), or by altering an appropriate existing record (or item), when a file is saved, or by removing an appropriate record (or item) when a file is deleted. The key of the record (or item) may correspond to that used for the unique label, or the unique volume label, though this is not necessarily true. As indicated by optional block 335, a synchronization may be effected (Recall, e.g., operations 262 and 258 of FIG. 2.) if possible. The method 212′ may then be left via RETURN node 360.

Referring back to conditional branch point 310, if the storage medium is determined not to be new, the method 212′ continues to block 330, which was just described above.

Naturally, there are many ways to assign unique volume labels. One exemplary way is to maintain a sequence count which may be initialized (e.g., to “1000”) when the content tracking application is installed onto the read/write machine (e.g., a personal computer). The unique volume label may be written by launching a DOS command such as “label a: {sequence count value}” within a JAVA application. When determining whether a current disk has a valid unique volume label, the (unique) volume label can be read and compared with the sequence count. If the read (unique) volume label is greater than the value of the sequence count (or less than the value of the initial sequence count), or is not an x-digit (e.g., 4-digit) number, then it may be deemed invalid.

Having described an exemplary method 212′ that may be used to effect the content tracking base operations 212, an exemplary method 242′ that may be used to effect the content tracking (non-base) operations 242 is now described with reference to FIG. 4.

FIG. 4 is a flow diagram of an exemplary method 242′ that may be used to effect the content tracking (non-base) operations 242. At conditional branch point 405, it is determined what type, if any, of user command has been entered.

If the user has requested a synchronization operation, the method 242′ flows to conditional branch point 470 which determines whether or not the non-base (handheld, untethered) device “is connected with” (i.e., can communicate with) a base machine. If not, an error message may be generated, as indicated by block 480. Alternatively, or in addition, a prompt to connect the (handheld, untethered) device with the base machine may be provided to the user. Referring back to conditional branch point 470, if the (handheld, untethered) device is connected with a base machine, the database instance on the (handheld, untethered) device (Recall e.g., 256 of FIG. 2.) may be updated to reflect any new records (or items), any deleted records (or items), and/or any altered records (or items). Alternatively, the database instance may simply be overwritten with data from the database of the file read/write machine (Recall, e.g., 222 of FIG. 2.). The method 242′ may then be left via RETURN node 490.

Referring back to conditional branch point 405, if the user has requested a display content operation, the method 242′ flows to block 410 which indicates that the user may be prompted to scan (labels). In response, the user should scan the label associated with (e.g., affixed to) the storage medium. At conditional branch point 415, it is determined whether or not a scan input was received. If not, a “time out” routine 465 may be executed. Such a “time out” routine 465 may wait a predetermined time for a proper user input. If none is received, it may then leave the method 242′. Referring back to conditional branch point 415, if a scan input is received, as indicated optional block 420, the code may be converted to a unique label (which may be used as the (media) key) (Recall 231 of FIG. 2.). Alternatively, such a conversion may have already been performed by the scanning operations 250, particularly if the unique label is the same as the (media) key. Using the key, records (or items) are requested and retrieved from the database instance, for example via database management operation(s) (Recall, e.g., 254 of FIG. 2.), as indicated by block 425. Then, as indicated in block 430, information (e.g., the file name) about the retrieved records (or items) may be rendered to the user. For example, the names (and/or other information) of files on the scanned storage media may be rendered on a display. (Recall, e.g., 244 and 248 of FIG. 2.) As indicated by conditional branch point 435, if the user then commands an exit, the method 242′ may be left via RETURN node 490.

Although not shown in FIG. 3, the content tracking base method(s) 212′ performed by the read/write machine 210 could support a similar “display content” function (assuming it 210 has a code reader) in the same manner as that just described with reference to blocks 410-430 of FIG. 4.

Referring back to conditional branch point 405, if the user has requested a find file operation, the method 242′ flows to block 440 which indicates that the user may be prompted for one or more search parameters (e.g., file name, size, author, type, etc.). As indicated by decision branch point 445, it is determined whether the search request was received (e.g., whether search parameters were entered). If not, a “time out” routine 465 may be executed. Such a “time out” routine 465 may wait a predetermined time for a proper user input. If none is received, it may then leave the method 242′. Referring back to conditional branch point 445, if a search request has been received, a query based on the search parameters is generated as indicated by block 450. Naturally, in an alternative embodiment, a user could directly generate a query, for example, by entering a query command line. The query may be provided to the database management operation(s) 254 which may provide records (or items) matching the search parameters. The records (or items) returned may then be accepted, and information associated with each record (or item) accepted may be rendered, as indicated in blocks 455 and 460, respectively. In one embodiment, the user can be prompted to scan, successively, labels associated with (e.g., affixed to) various storage media). Such a method could provide an audible and/or visual indication of whether or not the storage medium just scanned has a file(s) matching the search parameters. Referring back to FIG. 4, as indicated by conditional branch point 435, if the user then commands an exit, the method 242′ may be left via RETURN node 490.

Although not shown in FIG. 3, the content tracking database method(s) 212′ performed by the read/write device 210 could support a similar “find file” function, in the same manner as that just described with reference to blocks 440-460 of FIG. 4.

### 4.3.3 EXEMPLARY APPARATUS

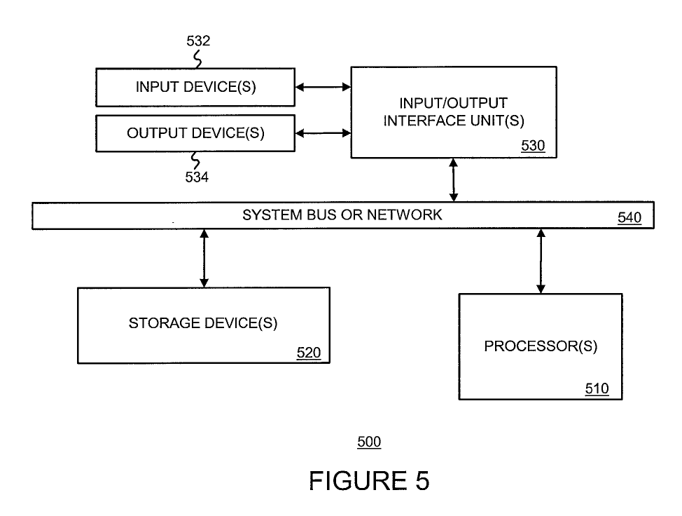

Referring to FIG. 5, the foregoing operations may be effected, and the foregoing data structures may be stored, by an apparatus 500 including a processor(s) (e.g., a microprocessor) 510, a storage device(s) 520 (such as RAM, ROM, magnetic, optical, and/or magneto-optic disks, and magnetic tape for example), input/output interfaces 530, an input device(s) 532 (such as a keyboard, a keypad, a pointing device, a microphone, a card reader, a signature capture device, a scanner, a touch screen, a stylus, and/or a video camera for example), an output device(s) 534 (such as a video monitor, a printer, and/or a speaker(s) for example), and a system bus or network 540. The processor(s) 510, input/output interface(s) 530, and storage device(s) 520 may communicate with one another via the system bus or network 540. The processor(s) 510 may execute program instructions. For example, at least some of the content tracking operations may be JAVA-based. JAVA is advantageous in that it is compatible with different types of databases. The program instructions may be stored on the storage device(s) 520 and/or received via the input/output interface unit(s) 530. Thus, for example, at least some of the operations may be effected by, and at least some of the data structures may be stored on, a personal computer, or a personal digital assistant.

### 4.3.4 ADDITIONAL OPTIONAL FEATURES

Since a storage medium (e.g., a diskette) may be used on multiple read/write machines (e.g., multiple computers), and since the validity of a (unique) volume label of the storage medium may be determined, at least in part, based on state information at a read/write machine, the invention may be extended so that a given storage medium can be used on different read/write machines.

For example, a unique product identifier can be assigned to each content tracking base application, and be recognized by each content tracking base application as identifying it or another instance of the application. For example, if personal computer A provides a unique volume label to a new diskette, it will also provide its product identifier. If that diskette is later used on personal computer B, the personal computer B will recognize the product identifier does not match its own product identifier. In such a case computer B would not use the diskette.

A better solution may be to write a unique product identifier, unique volume identifier pair for each read/write machine that uses the storage medium. In this way, each read/write machine would use only the information applicable to it. Alternatively, if all of the read/write machines that will use the storage medium are networked or can otherwise communicate with a central machine, that central machine can be used to track unique volume labels and sequence counts. In this way, the centrally stored and controlled state information would be coherent and consistent across all of the read/write machines.

### 4.4 EXAMPLES ILLUSTRATING OPERATIONS PERFORMED BY AN EXEMPLARY EMBODIMENT

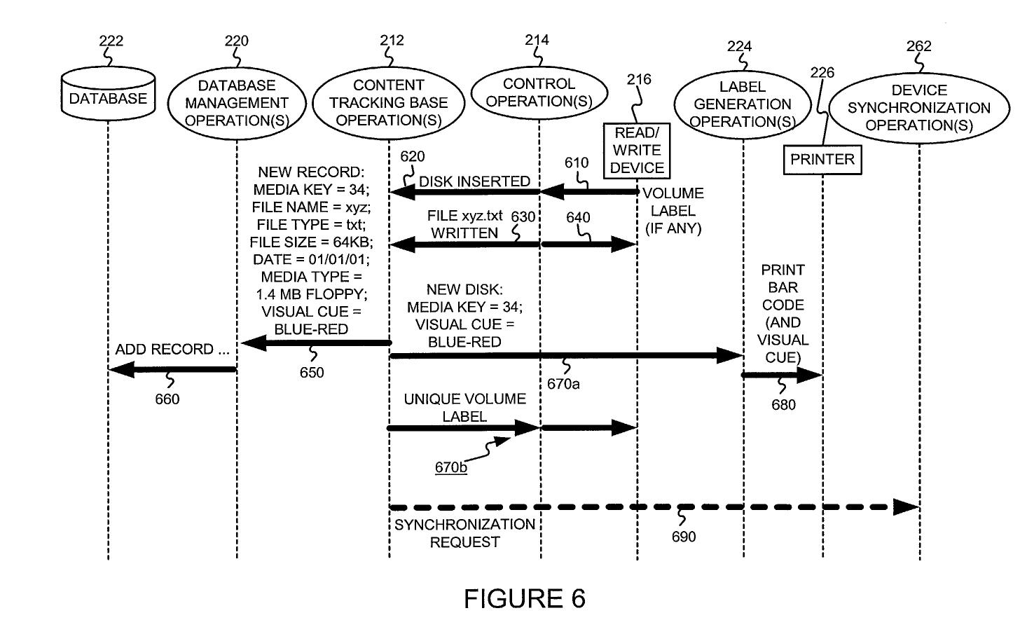

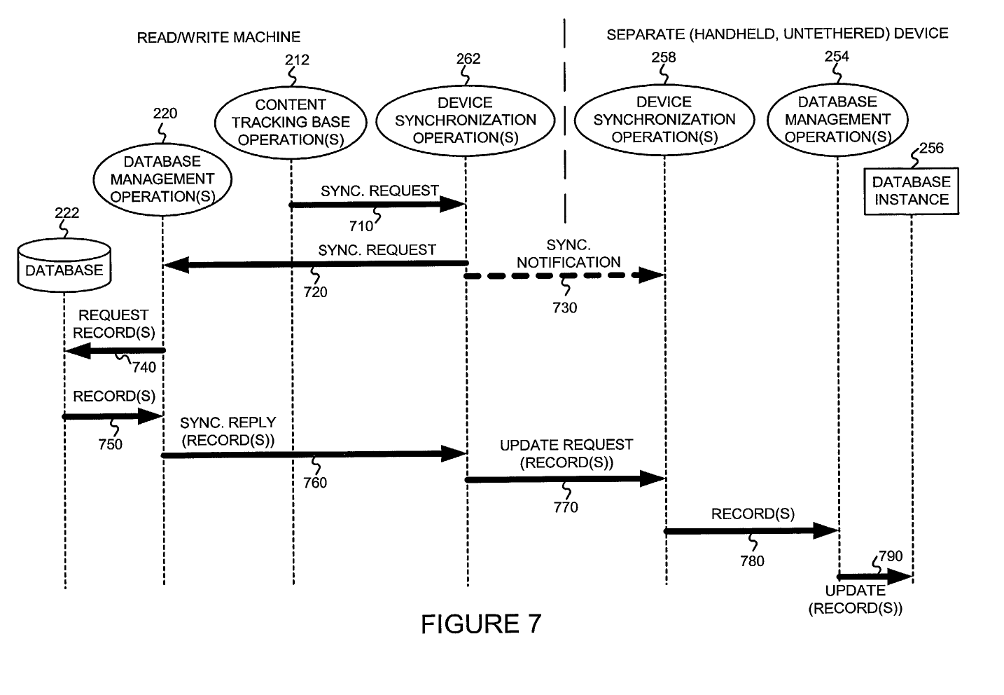

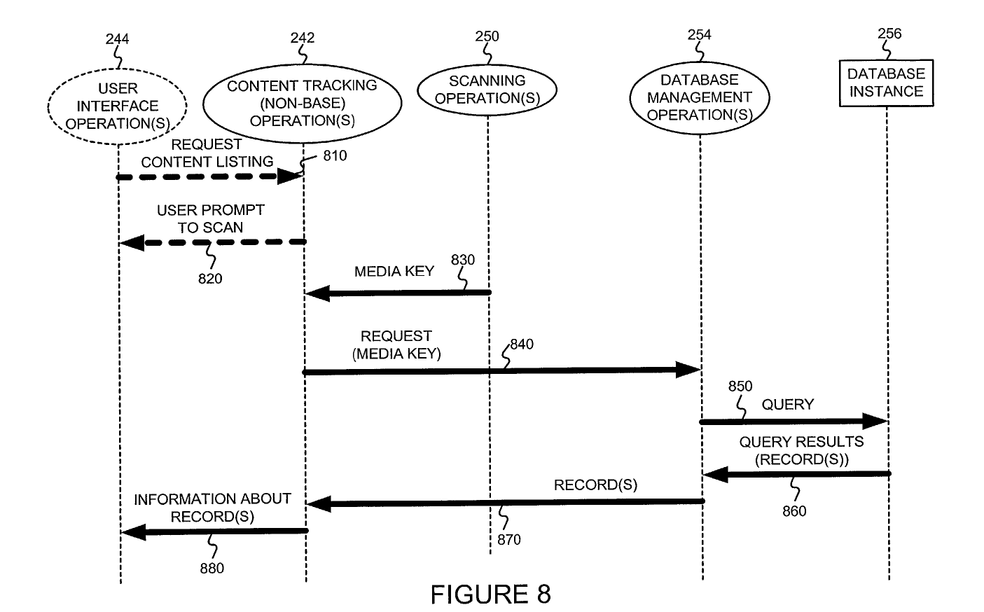

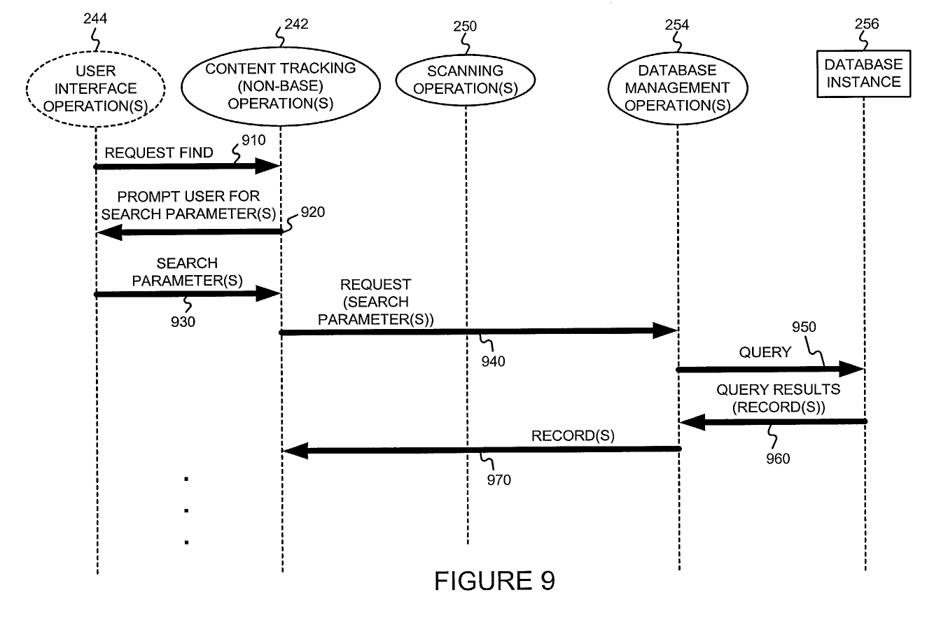

Various examples illustrating how various exemplary operations of the invention work, are now provided. An example illustrating what can occur when a new file is written onto a new diskette, is described in 4.4.1 with reference to FIG. 6. An example illustrating what can occur when a synchronization is requested is described in 4.4.2 with reference to FIG. 7. An example illustrating what can occur when a content listing is requested is described in 4.4.3 with reference to FIG. 8. Finally, an example illustrating what can occur when a find file is requested is described in 4.4.4 with reference to FIG. 9.

### 4.4.1 EXAMPLE

### Writing a New File to a New Diskette

FIG. 6 is a messaging diagram that illustrates what can occur when a new file is written onto a new diskette. A read/write device (e.g., a floppy disk drive) 216 may communicate to its controller 214 that a diskette has been inserted, as indicated by communication 610. This information may be forwarded to the content tracking base operation(s) 212 as indicated by communication 620. The communication 620 may include a unique volume label, if any, assigned to the diskette. Assuming that a text (“txt”) file named “xyz” is written to the diskette, this information is forwarded from the control operation(s) 214 to the content tracking base operation(s) as indicated by communication 630. The communication 630 may include other information about the file (being) written. The file xyz.txt may be forwarded to the read/write device 216, as indicated by communication 640, for purposes of writing it to the diskette. As indicated by communication 650, a new record request may be sent from the content tracking base operation(s) 212 to the database management operation(s) 220. This request may include a value (e.g., 34) for the media key field 231, a value (e.g., “xyz”) for the file name field 232, a value (e.g., “txt”) for the file type field 233, a value (e.g., 64 KB) for the file size field 234, a date (e.g., 01/01/01 ) for the date field 235, a value (e.g., 1.44 MB floppy) for the media type field 236 and values (e.g., blue-red) for the visual cue field 237. Using the information in this request, the database management operation(s) 220 may add a record to the database 222, as indicated by communication 660.

In this example, it is assumed that the diskette is new. That is, it is assumed that it does not yet have an associated label. Accordingly, the content tracking base operation(s) 212 may also communicate a print label request, including the media key and visual cue values, to the label generation operation(s) 224, as indicated by communication 670a. Then, as indicated by communication 680, the label generation operation(s) 224 will command a printer 226 to print a bar code corresponding to the media key value and colored shapes based on the visual cue values. The user may then associate this label with (e.g., affix the label to) the new diskette. A unique volume label may also be written to the new diskette, via control operation(s) 214, as indicated by communication 670b. To reiterate, the value of the unique volume label may correspond to the media key value, though this is not necessary.

Since a new record was created, the content tracking operation(s) 212 may also submit a synchronization request to the device synchronization operation(s), as indicated by communication 690.

### 4.4.2 EXAMPLE

### Synchronization

FIG. 7 is a messaging diagram that illustrates what can occur when a synchronization request is generated by (or through) the content tracking base operation(s) 212. Such a request can be generated pursuant to an explicit user request (entered at the read/write machine, or at the untethered device), or pursuant to a change in the contents of a storage medium. The request, indicated by communication 710, is forwarded to the device synchronization operation(s) 262 of the file read/write machine (e.g., a personal computer). The device synchronization operation(s) 262 may forward the request to the database management operation(s) 220 as indicated by communication 720. It may also notify its counterpart operation(s) 258 in a (handheld, untethered) device as indicated by communication 730. Pursuant to the receipt of a synchronization request, the database management operation(s) 220 may request records from the database 222, as indicated by communication 740, and the requested records may be returned as indicated by communication 750. The database management operation(s) 220 may then forward the record(s), as a part of a synchronization reply communication 760, to the device synchronization operation(s) 262. The record(s), as part of an update request communication 770, may then be provided to the device synchronization operation(s) 258 of the (handheld, untethered) device. Then, as indicated by communication 780, the device synchronization operation(s) 258 may provide record(s) to the database management operation(s) 254, which may, in turn, submit an update record(s) communication 790 to the database instance 256 of the (handheld, untethered) device. In this way, records (or items) in the database instance 256 can be made coherent with those in the database 222.

### 4.4.3 EXAMPLE

### Show Contents

FIG. 8 is a messaging diagram that illustrates what can occur when a content listing utility is requested. As shown by communication 810, a user request for a content listing (of a storage medium) may be provided from a user interface 244 to content tracking (non-base) operation(s) 242. In response, as indicated by communication 820, the content tracking (non-base) operation(s) 242 may provide a prompt to a user, via the user interface 242, to have the user scan a storage medium label as indicated by communication 820. Assuming that the user scans the label, the scanning operation(s) 250 may then provide the media key to the content tracking (non-base) operation(s), as indicated by communication 830. A request communication 840, including this media key, may then be sent from the content tracking (non-base) operation(s) 242 to database management operation(s) 254. The database management operation(s) 254 may use this request 840 to generate a query to its database instance 256, as indicated by communication 850. A query result(s), which may include one or more records (or items), may be returned from the database instance 256 to the database management operation(s) 254 as indicated by communication 860. The database management operation(s) 254 may then provide the returned record(s) (or items(s)) to the content tracking (non-base) operation(s) 242, as indicated by communication 870. The content tracking (non-base) operation(s) 242 may then send information about the returned record(s) (or item(s)) to the user interface 244, as indicated by communication 860. This information may then be rendered to the user (e.g., in the form of a display screen).

### 4.4.42 EXAMPLE

### Find File

FIG. 9 is a messaging diagram that illustrates what can occur when a find file utility is requested. As indicated by communication 910, a find file request may be provided to the content tracking (non-base) operation(s) 242 via the user interface operation(s) 244. In response, the content tracking (non-base) operation(s) 242 may prompt the user, via the user interface operation(s) 244, for one or more search parameters (e.g., file name, file size, file type, author, etc.), as indicated by communication 920. The user may enter such search parameter(s), via the user interface operation(s) 244, as indicated by communication 930. Using the entered search parameter(s), the content tracking (non-base) operation(s) 242 generate a request to the database management operation(s) 254, as indicated by communication 940. The database management operation(s) 254 may use this request 940 to generate a query to its database instance 256, as indicated by communication 950. A query result(s), which may include one or more records (or items), may be returned from the database instance 256 to the database management operation(s) 254 as indicated by communication 960. The database management operation(s) 254 may then provide the returned record(s) (or items(s)) to the content tracking (non-base) operation(s) 242, as indicated by communication 970. The content tracking (non-base) operation(s) 242 may then use this information to help the user find the storage medium having the file that they want. It 242 may do so by displaying the media key (e.g., a number) and/or the visual cues to the user, so that the user can then use this information to find the storage medium storing the file that they are looking for. Alternatively, the content tracking (non-base) operation(s) 242 may then use this information to help the user find the storage medium having the file that they want by checking successive scanner inputs for a match with the media key in the returned record(s), and indicating a match or no match (e.g., with audible beeps of different tones) to the user.

### 4.5 CONCLUSIONS

As can be appreciated from the foregoing, the present invention helps users track the contents of various types of storage media. Advantageously, it is not necessary to actually read the storage medium by a machine (e.g., inserted into the appropriate drive of a personal computer). The present invention can track a large number of files, and can easily track the addition or deletion of files.

What is claimed is:

1. For use by a read/write machine, a method for assigning a unique label to a storage medium, the method comprising:
a) determining whether or not the storage medium has been considered before;
b) if the storage medium has not been considered before, then
(i) determining a unique label identifier,
(ii) determining a unique volume label,
(iii) writing the unique volume label onto the storage medium, and
(iv) providing a command to generate a label based on the unique label identifier, the label to be associated with the storage medium; and
c) updating a database based on files added to or deleted from the storage medium.

2. The method of claim 1 further comprising:
d) synchronizing the database with a database on a device apart from the read/write machine.

3. The method of claim 2 wherein the read/write machine is a personal computer and the device is a handheld device.

4. The method of claim 3 wherein the device is an untethered handheld device.

5. The method of claim 1 wherein the read/write machine is a computer with at least one of (a) a floppy disk drive, (b) a CD ROM drive, (c) a ZIP drive, and (d) a DVD drive.

6. The method of claim 1 wherein the label based on the unique label identifier is a bar code label.

7. The method of claim 1 wherein the act of determining a unique volume label is based, at least in part, on state information accessible to the read/write machine.

8. The method of claim 7 wherein the state information is a count sequence.

9. The method of claim 1 wherein the database includes records, each record including a first field having a value associated with the unique volume label, and a second field having a value associated with a file stored on the storage medium.

10. A method for determining the contents of a storage medium without reading the storage medium, the method comprising:
a) accepting information read from a label associated with the storage medium;
b) converting the accepted information into a database key;
c) requesting records from a database instance using the database key;
d) accepting records in response to the request; and
e) rendering information about the accepted records.

11. The method of claim 10 wherein the label associated with the storage medium is a bar code and wherein the information read from the label is accepted from a bar code scanner.

12. The method of claim 10 wherein the information about the accepted records rendered includes file names.

13. The method of claim 12 wherein the accepted information read from a label associated with the storage medium is read by a handheld device, and the information about the accepted records is rendered on the handheld device.

14. The method of claim 13 wherein the read label is converted into a database key by the handheld device, the records are requested from a database instance using the database key by the handheld device, and the records are accepted in response to the request by the handheld device.

15. A method for matching file parameters with one or more storage media, each of the one or more storage media having an associated label, the method comprising:
a) accepting one or more search parameters;
b) generating a query based on the search parameters;
c) accepting one or more records returned in response to the query generated;
d) rendering information associated with each of the one or more records accepted, the information rendered being related to the label associated with the storage medium storing one or more files identified with the one or more records accepted.

16. The method of claim 15 wherein the labels are machine-readable labels, the method further comprising:
e) accepting information read from the machine-readable labels;
f) if the accepted information read from the machine-readable labels matches information associated with any one of the one or more records accepted, then generating a first indicator, said first indicator able to be perceived by humans.

17. The method of claim 16 further comprising:
g) if the accepted information read from the machine-readable labels does not match information associated with any one of the one or more records accepted, then generating a second indicator, said second indicator able to be perceived by humans.

18. The method of claim 17 wherein the first indicator is a first audible sound, and the second indicator is a second audible sound.

19. The method of claim 15 wherein each of the labels include human-readable part, and wherein the information associated with each of the one or more records accepted corresponds to the human-readable part of the labels.

20. An apparatus for assigning a unique label to a removable storage medium, the apparatus comprising:
a) means for reading files from and/or writing files to a removable storage medium;
b) means for generating a label;
c) means for determining whether or not the removable storage medium has been considered before;
d) means, if the storage medium has not been considered before, for
(i) determining a unique label identifier,
(ii) determining a unique volume label,
(iii) instructing the means for reading and/or writing files to write the unique volume label onto the storage medium, and
(iv) providing a command to generate a label based on the unique label identifier, to the means for generating a label; and
e) a database, wherein the database is updated based on files added to or deleted from the removable storage medium.

21. The apparatus of claim 20 further comprising:
f) means for synchronizing the database with a database on a device apart from the apparatus.

22. The apparatus of claim 21 wherein the device is a handheld device.

23. The apparatus of claim 21 wherein the device is an untethered, handheld device.

24. The apparatus of claim 20 wherein the means for reading files from and/or writing files to a removable storage medium are at least one of (a) a floppy disk drive, (b) a CD ROM drive, (c) a ZIP drive, and (d) a DVD drive.

25. The apparatus of claim 20 wherein the label is a bar code label.

26. The apparatus of claim 20 further comprising:
f) state information, wherein the unique volume label is determined, at least in part, based on the state information.

27. The apparatus of claim 26 wherein the state information is a count sequence.

28. The apparatus of claim 20 wherein the database includes records, each record including a first field having a value associated with the unique volume label, and a second field having a value associated with a file stored on the removable storage medium.

29. An apparatus for determining the contents of a storage medium without reading the storage medium, the apparatus comprising:
a) means for reading a label associated with the storage medium;
b) means for accepting information read, by the means for reading, from a label associated with the storage medium;
c) means for converting the read label into a database key;
d) means for requesting records from a database instance using the database key;
d) means for accepting records in response to the request; and
e) means for rendering information about the accepted records.

30. The apparatus of claim 29 wherein the means for reading is a bar code scanner, and wherein the label associated with the storage medium is a bar code.

31. The apparatus of claim 29 wherein the information about the accepted records rendered includes file names.

32. The apparatus of claim 29 wherein the means for rendering is a display.

33. The apparatus of claim 29 further comprising:
f) the database.

34. The apparatus of claim 33 further comprising:
g) means for synchronizing the database with a database maintained by a separate machine which created the storage medium.

35. An apparatus for matching file parameters with one or more storage media, each of the one or more storage media having an associated label, the apparatus comprising:
a) a user input for accepting one or more search parameters;
b) means for generating a query based on the accepted one or more search parameters;
c) means for accepting one or more records returned in response to the query generated;
d) means for rendering information associated with each of the one or more records accepted, the information rendered being related to the label associated with the storage medium storing one or more files identified with the one or more records accepted.

36. The apparatus of claim 35 wherein the labels are machine-readable labels, the apparatus further comprising:
e) a label reader for reading information read from the machine-readable labels; and
f) an output means for generating a first indicator able to be perceived by humans if the accepted information read from the machine-readable labels matches information associated with any one of the one or more records accepted.

37. The apparatus of claim 36 wherein the output means further generates a second indicator able to be perceived by humans if the accepted information read from the machine-readable labels does not match information associated with any one of the one or more records accepted.

38. The apparatus of claim 37 wherein the output means is a speaker, wherein the first indicator is a first audible sound, and wherein the second indicator is a second audible sound.

39. The apparatus of claim 35 wherein each of the labels include human-readable part, and wherein the information associated with each of the one or more records accepted corresponds to the human-readable part of the labels.
